(19) United States
(12) Patent Application Publication
(10) Pub. No.: US 2024/0020779 A1
(43) Pub. Date: Jan. 18, 2024

(54) METHOD AND SYSTEM OF DIGITALLY SECURING AND TRANSFERRING ASSETS

(71) Applicant: BQuest, LLC, Excelsior, MN (US)

(72) Inventors: Michael Larsen, Yorba Linda, CA (US); Damon Johnson, Excelsior, MN (US); Brett Robinson, Seattle, WA (US)

(21) Appl. No.: 18/301,129

(22) Filed: Apr. 14, 2023

Related U.S. Application Data
(60) Provisional application No. 63/363,007, filed on Apr. 14, 2022.

(51) Int. Cl. G06Q 50/18; G06Q 20/38; G06Q 20/12; G06Q 40/06

(52) U.S. Cl. CPC G06Q 50/186; G06Q 20/3829; G06Q 20/1235; G06Q 40/06

(57) ABSTRACT

Digitally securing and transferring assets includes: securing an asset in a digital vault using a unique key; storing the vault in a first database and storing the key in a second database; creating a distribution plan for the asset; detecting a trigger event; and, detecting the trigger event, transferring the asset, and automatically creating legal documents. Transferring a digital asset includes: detecting a trigger event, retrieving a benefactor's public key; retrieving a beneficiary's private key; using the private key to decrypt the asset; encrypt the asset with a new beneficiary public key; store the new beneficiary public key; store the digital asset to reflect the new ownership record. An estate recommendation includes: comparing an allocation and market values of assets to similar estates in the database, creating a first comparison; creating a second comparison using an external database; and using the first and second comparison to create a recommendation automatically.

### CROSS-REFERENCE TO RELATED APPLICATIONS

This application claims the benefit of priority to U.S. Provisional Patent Application No. 63/363,007, filed Apr. 14, 2022, the contents of which is incorporated by reference herein in its entirety.

### FIELD OF THE DISCLOSURE

The present solution relates to digitally securing and transferring assets and more particularly to estate planning using digitally secure assets.

### BACKGROUND

Currently, methods for estate planning, including the creation of wills and executing them, do not offer a simple and automatic solution for the holistic management and transfer of physical assets, digital assets (i.e. photos, videos, non-fungible tokens), cryptocurrencies, and other accounts (i.e. banks, investment accounts). These types of assets are being purchased, created and owned by more and more people every day. There is currently no way to include these assets into a traditional trust or will in a way that allows them to be added and managed easily, transferred to beneficiaries automatically, and safe from potential loss. Additionally, current estate planning and will methods are cumbersome in the way ownership of tangible assets are transferred; and, the transfer of these assets is oftentimes very slow and necessitates the involvement of intermediaries including, courts, governmental records offices, attorneys and banks. There is currently no solution by which the ownership of these types of assets can be represented and managed digitally and transferred automatically. Finally, when a person dies, beneficiaries must go through many hurdles including probate, proof of power of attorney, and visit with multiple parties in order to secure the transfer of these assets. There is a technological need for a mechanism in which tangible assets can be secured digitally and transferred along with digital assets in a distribution plan. Therefore, improvements are desirable.

### SUMMARY

The present invention seeks to provide an autonomous solution to these problems by providing a mechanism by which the location and details of the assets of a person can be collected, organized, and digitally documented along with information required to automatically and legally transfer those assets to another person or persons. In addition, the present invention facilitates the creation of a digital record of ownership in a database, or blockchain, viewable in a digital vault, for tangible personal property and other tangible assets and facilitates the transfer of ownership automatically from the user to another person or persons. The user is able to set criteria that must be met to trigger the transfer of the user's assets, including but not limited to a specific date or upon the user's death. Both of these tangible and digital assets can be secured and transferred digitally using the present invention.

In one aspect of the present invention, a method of digitally securing and transferring assets includes: securing a benefactor's asset in a digital vault using a benefactor's unique key; storing the digital vault in a first database, and storing the unique key in a second database separate from the first database ; creating a distribution plan for the digital asset; detecting a trigger event; and upon detecting the trigger event, transferring the digital asset. Digital vaults are created for the benefactor and beneficiaries as a digital representation of the estate's assets.

In another aspect of the present invention, a method of transferring a digital asset includes: upon detecting a trigger event, retrieving a benefactor's public key from a keystore; retrieving a beneficiary's private key from the key store; using the private key to decrypt the digital asset; encrypt the digital asset with a new beneficiary public key; store the new beneficiary public key in the keystore; store the digital asset in a database to reflect the new ownership record.

In another aspect of the present invention, a method of creating an estate recommendation includes: receiving a database trigger for a first estate in a database that includes an allocation of asset types and values by asset types; comparing the allocation and values to other estates in the database having a similar allocation and values to create a first comparison; comparing the allocation and values to other estates in an internal or external database having a similar allocation and values to create a second comparison; and using the first and second comparison to create a recommendation for the first estate automatically without any other input.

### BRIEF DESCRIPTION OF THE DRAWINGS

FIG. 1 is a user interface for entering a physical asset, according to one example embodiment of the present invention.

FIG. 2 is a user interface for selecting of types of assets, according to one example embodiment of the present invention.

FIG. 3 is a user interface for adding or modifying beneficiaries, according to one example embodiment of the present invention.

FIG. 4 is a user interface for entering or editing details about a beneficiary, according to one example embodiment of the present invention.

FIG. 5 is a view of an estate summary, according to one example embodiment of the present invention.

FIG. 6 is a view of a benefactor vault, according to one example embodiment of the present invention.

FIG. 7 is a view of a trustee/beneficiary summary and asset allocations, according to one example embodiment of the present invention.

FIG. 8 is a view of a summary of the digital representation of physical assets, according to one example embodiment of the present invention.

FIG. 9 is a view of a summary of digital assets, according to one example embodiment of the present invention.

FIG. 10 is a view of a beneficiary vault, according to one example embodiment of the present invention.

FIG. 11 is a general account activity ledger, according to one example embodiment of the present invention.

FIG. 12 is a user interface for entering or editing personal information about the user, according to one example embodiment of the present invention.

FIG. 13 is a view of a declaration of trust page, according to one example embodiment of the present invention.

FIG. 14 is a view of a beneficiary signature page, according to one example embodiment of the present invention.

FIG. 15 is a view of an account summary page, according to one example embodiment of the present invention.

FIG. 16A is a flow diagram of a method of digitally securing and transferring assets, according to one example embodiment of the present invention.

FIG. 16B is a flow diagram of a method of digitally securing and transferring assets, according to another example embodiment of the present invention.

FIG. 17 is a flow diagram of securing a digital asset, according to an example embodiment of the present invention.

FIG. 18 is a flow diagram of transfer of a digital asset, according to an example embodiment of the present invention.

FIG. 19 is a flow diagram illustrating changes to assets and beneficiaries require a signature, according to an example embodiment of the present invention.

FIG. 20 is a flow diagram of an estate recommendation engine, according to one example embodiment of the present invention.

FIG. 21 is a block diagram illustrating a computer network according to one embodiment of the disclosure.

FIG. 22 is a block diagram illustrating a computer system according to one embodiment of the disclosure.

### DETAILED DESCRIPTION

The present invention combines a digital platform with an interface that holds assets digitally and connects them to an external secure database, such as a blockchain(s). Of course, alternatives such as centralized databases, centralized ledgers, cloud storage, decentralized storage, distributed databases, other distributed ledgers, or other storage devices could be utilized. This unique process creates ownership of physical and digital assets through a digital process that contains five types of information: 1) identifying data for tangible assets (i.e. images, market values, description, etc.), 2) vault addresses and keys for cryptocurrencies, tokens (both fungible and non-fungible, 3) connections to obtain the balance of bank accounts and other investment accounts, 4) personal information from the benefactor and beneficiaries (i.e. name, address, etc.) and 5) the articles that detail the users wishes for distributions of his/her assets and property. Utilizing the present invention, users can do their estate planning and set up a will or distribution plan by themselves that can transfer assets at speeds not achievable today using traditional estate planning methods. This also includes digital files (i.e. photos, videos) that are not readily available for distribution via a traditional estate plan. Additionally, in the case of cryptocurrencies and other digital assets, if leveraging the blockchain, those transfers are borderless and jurisdictionless. By way of example, using the present invention, a user in the United States could transfer digital assets, to a beneficiary in another sovereign country in minutes without complications arising from differing laws and courts.

A Token is a digital representation of value or rights. A blockchain is a distributed database that is shared among the nodes of a computer network. A blockchain is a database arranged in connected blocks rather than tables. The blockchain collects information in sets called blocks. These blocks have certain storage capacities and when filled are permanently closed. All new information that follows is put in a new block linked to the previous closed block. This data structure creates an irreversible time line of data that is set in stone and cannot be changed. Once a block is closed, it cannot be altered and is cryptographically secured with a unique key. The unique key is typically stored in a different location than the blockchain and is typically recorded to yet another different location as a backup.

Preferably, the present solution is implemented in a web page or application that guides users though all the necessary profile and personal questions required to create a plan for the distribution of their assets. Users input information about their assets, digital and non-digital. Different asset types are organized into a graphical representation that they can later navigate and interact with easily. Users input image files and descriptive information of tangible assets to create a digital representation of ownership of each asset. This estate plan is stored on a ledger that is contained on the database, or a blockchain. Users are asked questions pertaining to the required and typical articles of a legally binding will or trust. They input the answers to these questions and answers. Users are asked whether they would like the transfer of their assets to be triggered immediately, by a specific date, confirmation of their death, or some other event. Information gathered in the aforementioned steps is recorded and saved. The transaction identifier is recorded in the user's account for reference and future access. Appropriate legal documents in the form of a will, trust, or estate plan are then automatically created from the information collected.

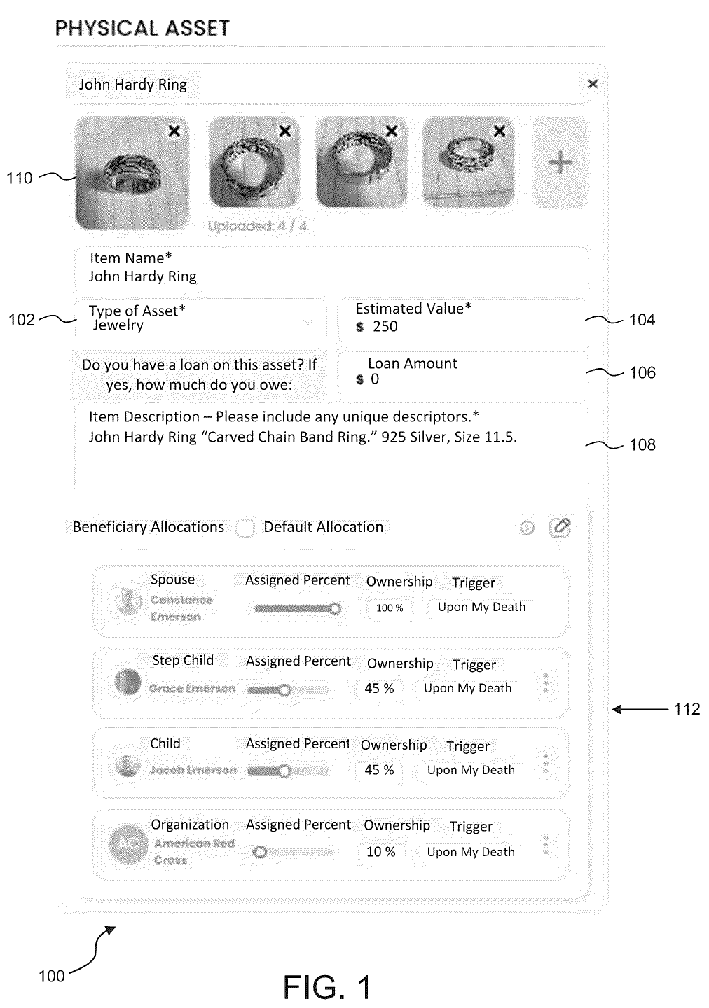

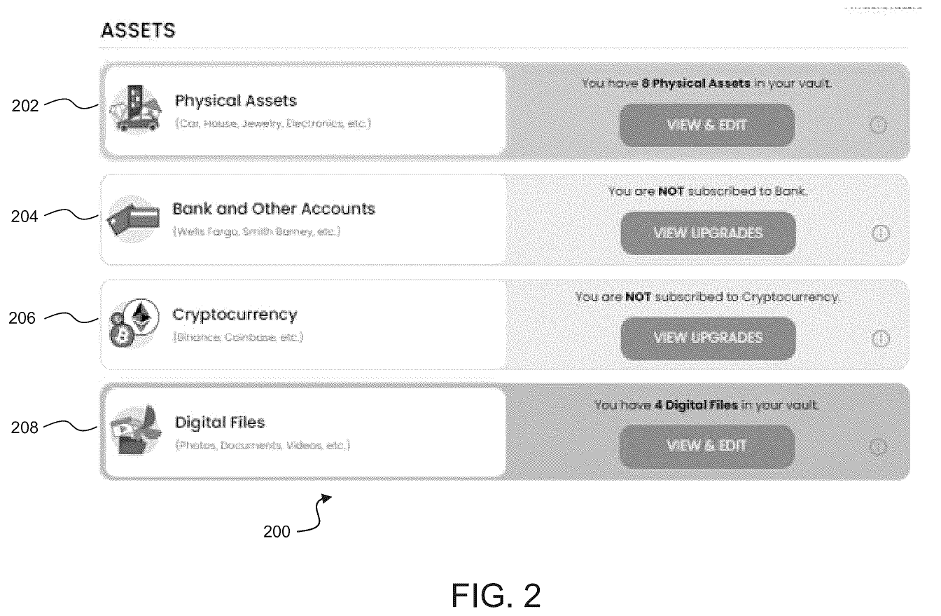

FIGS. 1-15 are example user interfaces that users may use to create a plan. Referring to FIG. 1, a user is entering information regarding a physical asset 100, a piece of jewelry, to be included in his/her estate. Such information can include a type of asset 102, a value 104, a loan amount 106, a description 108, photos 110, and other information. In addition, the user can identify beneficiary allocations 112. Referring to FIG. 2, an example of the different types of assets 200 that can be entered is illustrated. The assets 200 include physical assets 202, bank or other accounts 204, cryptocurrency 206 or digital files 208. The physical assets 202 can include cars, houses, boats, jewelry, electronics, etc. The digital files 208 can include photos, documents, videos, etc.

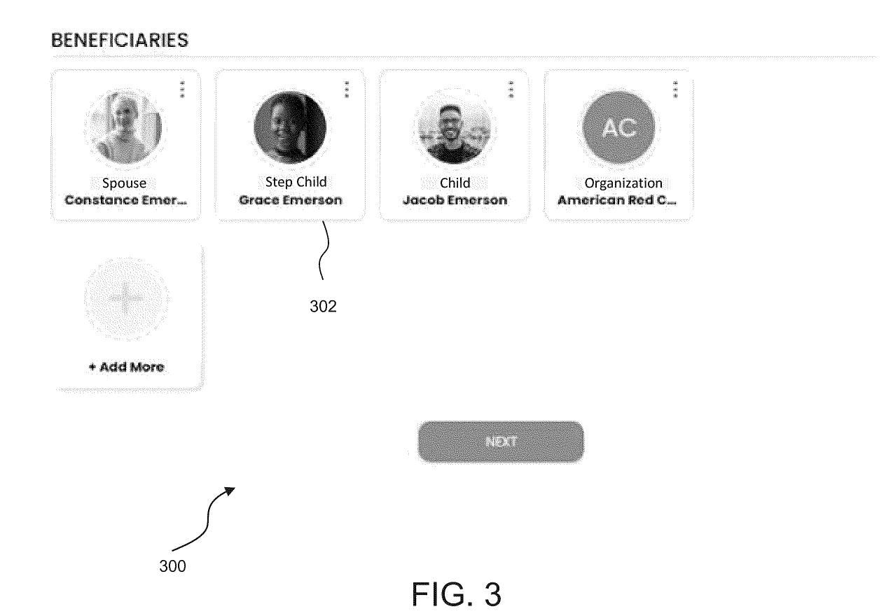

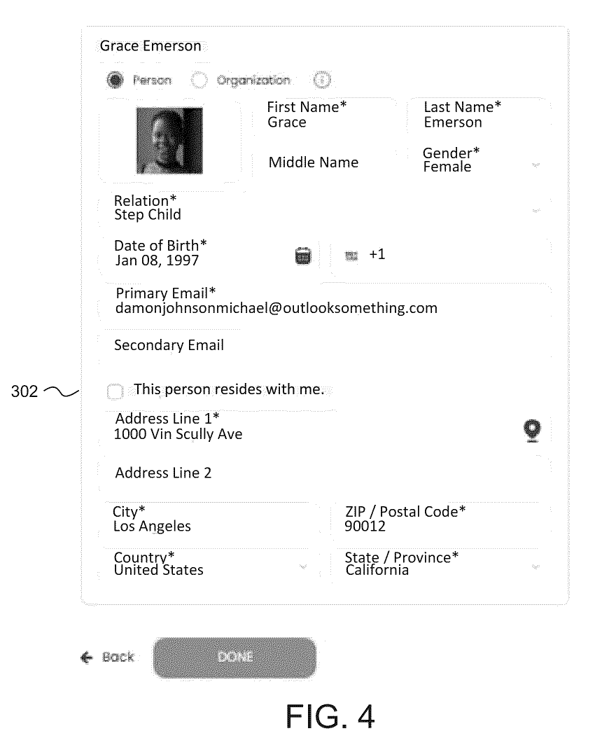

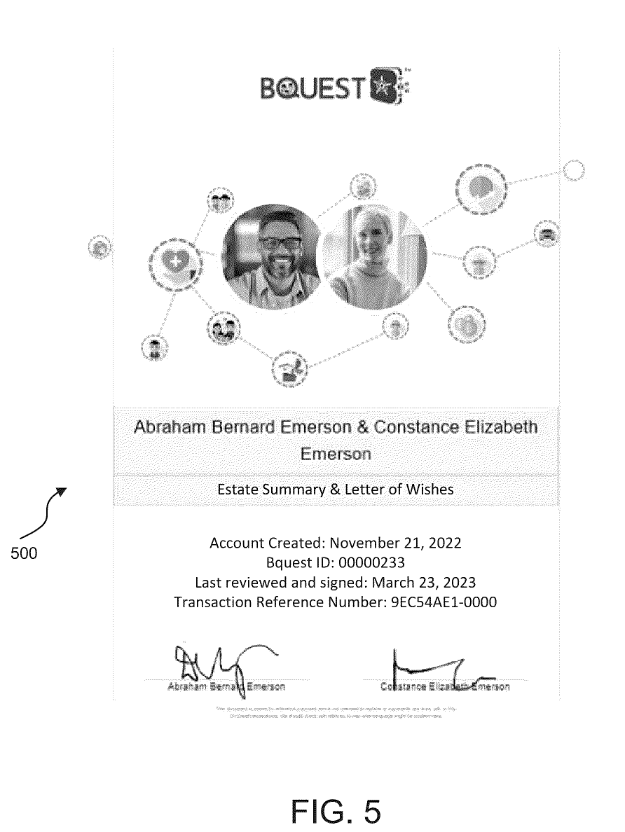

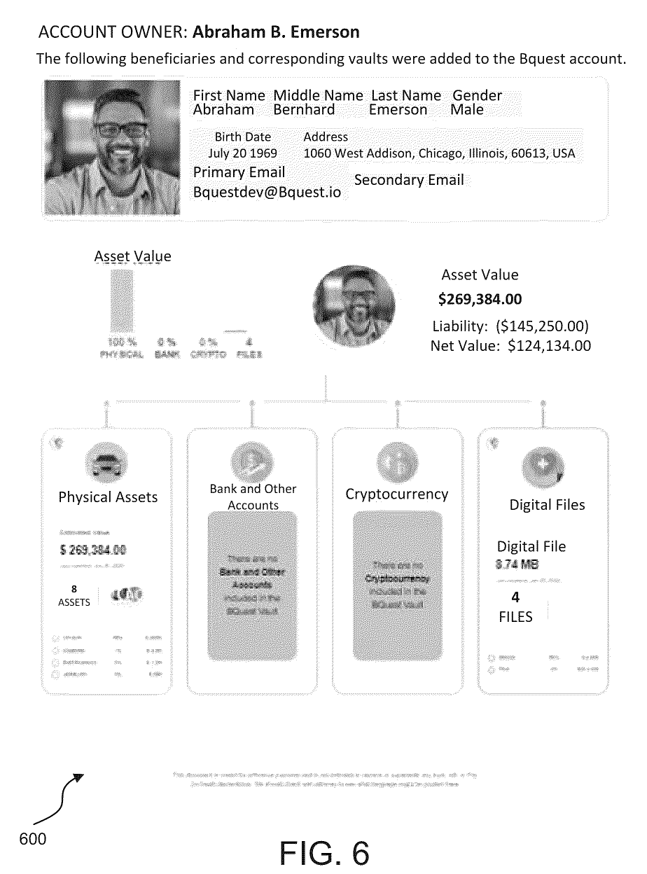

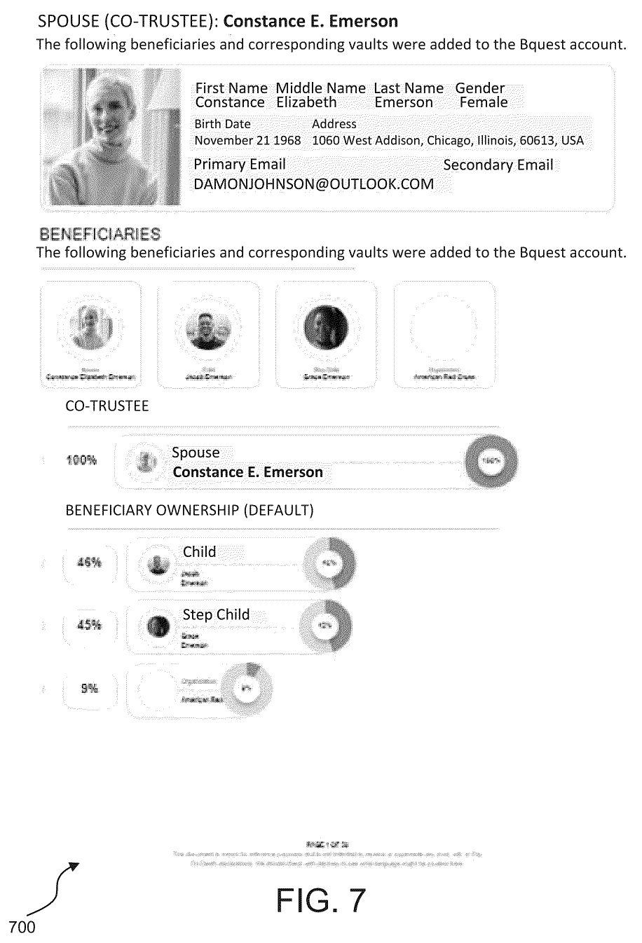

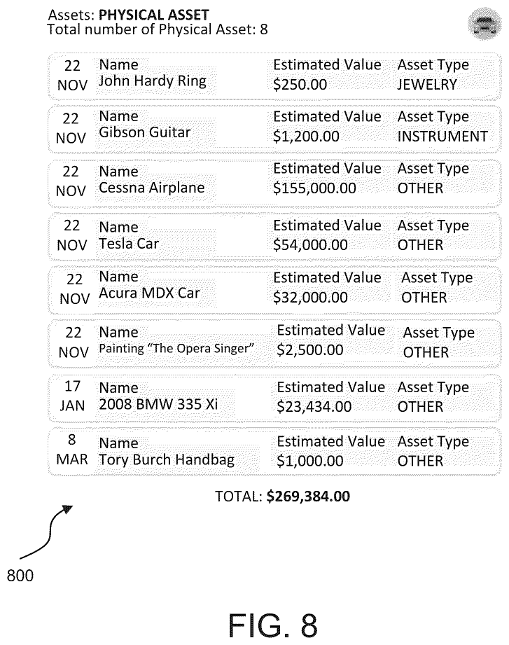

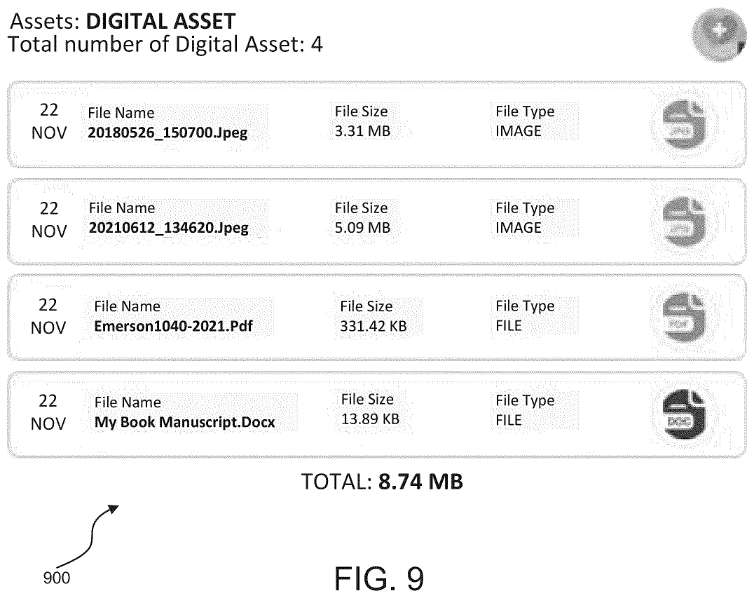

Referring to FIG. 3, the user can view beneficiaries 300, such as a first beneficiary 302. The user can edit, add or delete beneficiaries. Referring to FIG. 4, the first beneficiary 302 is shown in more detail including information about the beneficiary. Referring to FIG. 5, an estate summary 500 of the estate plan is presented, which includes the beneficiaries, assets, last reviewed and signed date and the actual signatures among other information. Referring to FIG. 6, an asset summary 600 of the account owner is illustrated, which includes all of the assets entered into the system. Referring to FIG. 7, a trustee summary 700 of the trustee and beneficiaries is illustrated. Referring to FIG. 8, a physical asset summary 800 is illustrated. Referring to FIG. 9, a digital asset summary 900 is illustrated.

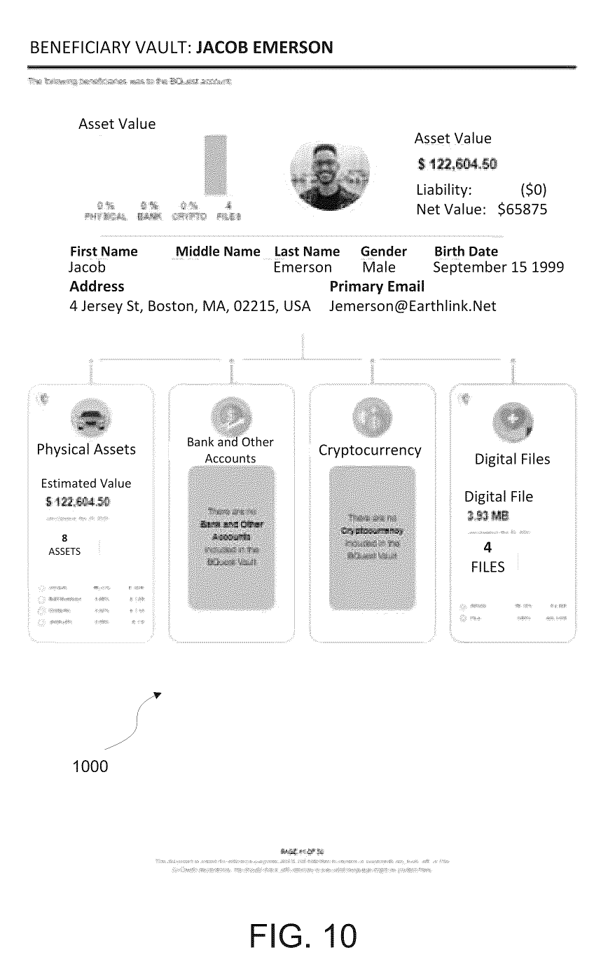

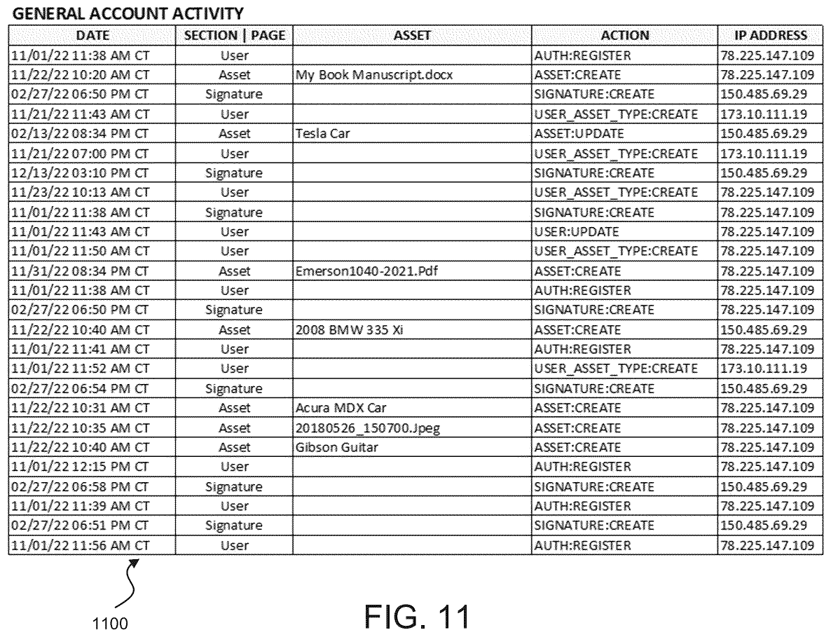

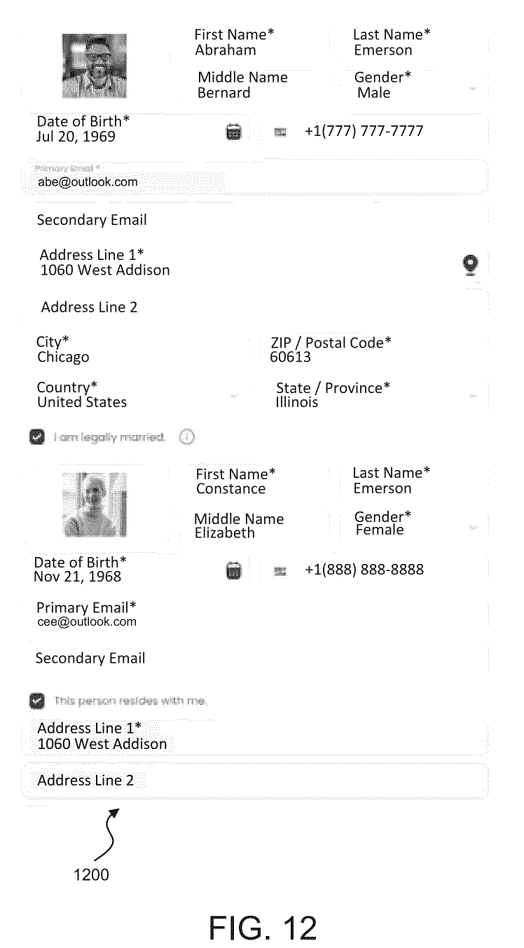

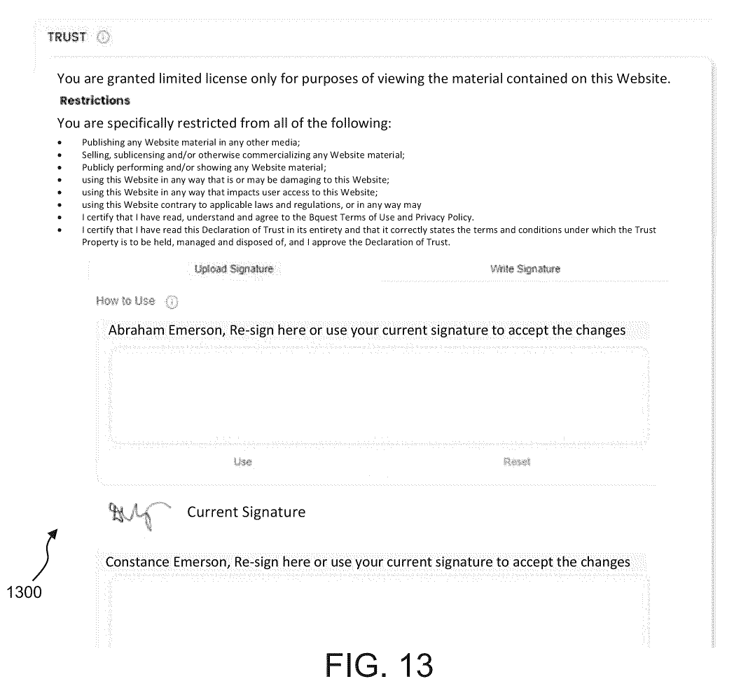

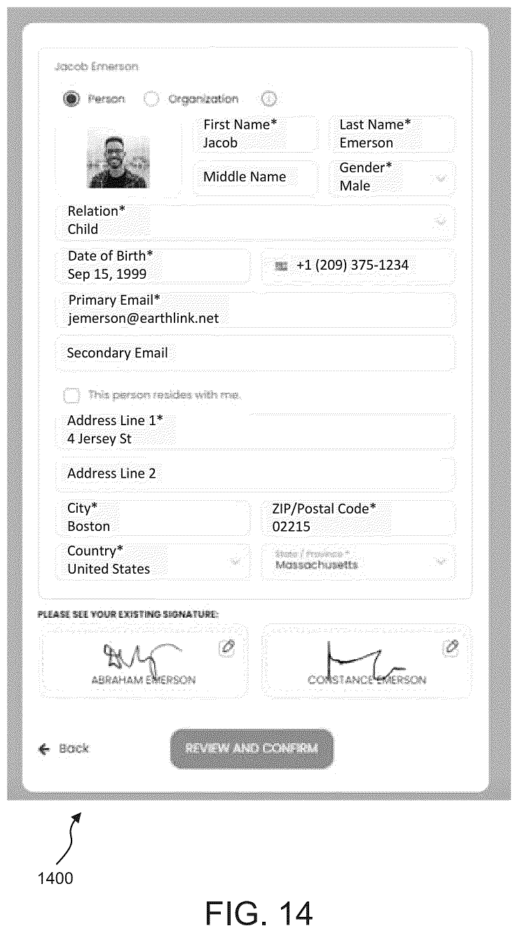

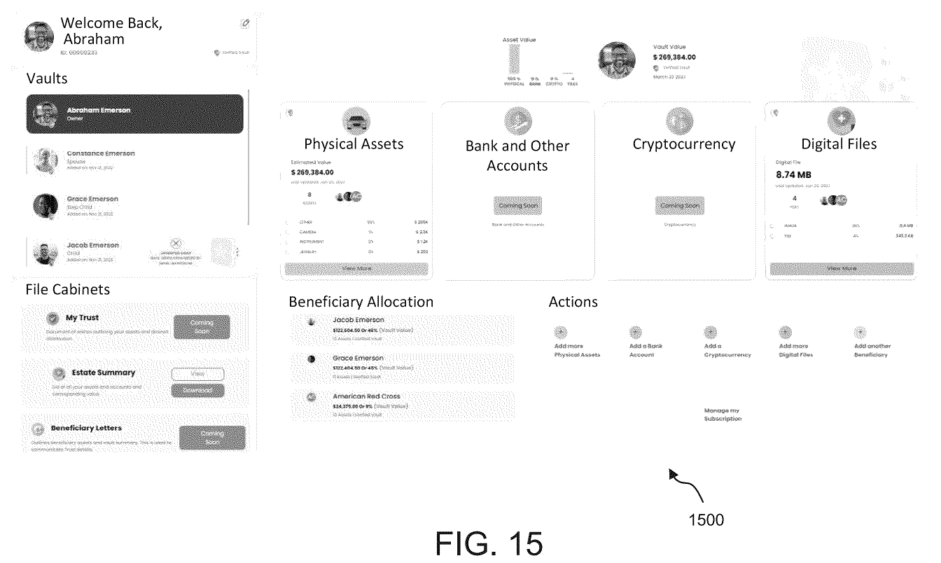

Referring to FIG. 10, a beneficiary can view a beneficiary summary 1000 of his/her share of the assets. Referring to FIG. 11, a general account activity ledger 1100 is illustrated. The system keeps track of all activity for the account. As such, any changes to the distribution plan, beneficiaries, assets, etc. can be tracked through time. Referring to FIG. 12, a user can input or edit his/her personal information 1200. Referring to FIG. 13, the account holder or benefactor, signs the Declaration of Trust 1300. Preferably, this signature is required each time the account holder makes a change to the trust, for example a beneficiary change or asset change. This signature and new signature would be tracked via the general account activity ledger 1100 of FIG. 11. Referring to FIG. 14, the beneficiaries also sign 1400. Referring to FIG. 15, an example home page 1500 for the account holder is illustrated.

For distribution of the assets, there are certain trigger events. One event can be immediate—user is able to initiate a transfer. Another event can be by a certain date. If the date equals the user's defined transfer trigger date, then the system transfers the assets to the beneficiary's(ies') vault(s). Another event can be death—the system checks the vital records database for confirmation of the issuance of a death certificate for the user. If the database returns a value that equals the issuance of a death certificate, then the system transfers the assets to the beneficiary's(ies') vault(s). Any suitable trigger event can be defined by the user.

The system automatically transfers the assets as defined by the user from the user's vault(s) to his/her designated beneficiary's(ies') vault(s). The vital records database contains up to date information on issuance of official death certificates. The user's transferred assets are received by the beneficiary's(ies') vault(s) and the beneficiaries are notified of transfer via email or text message.

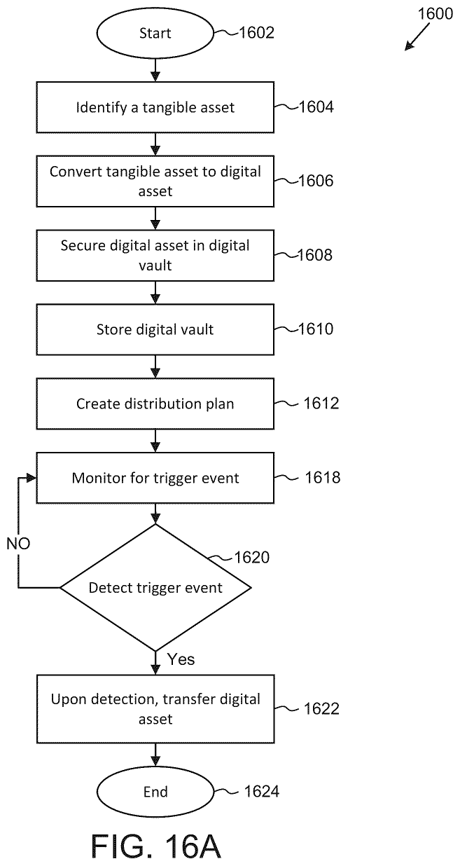

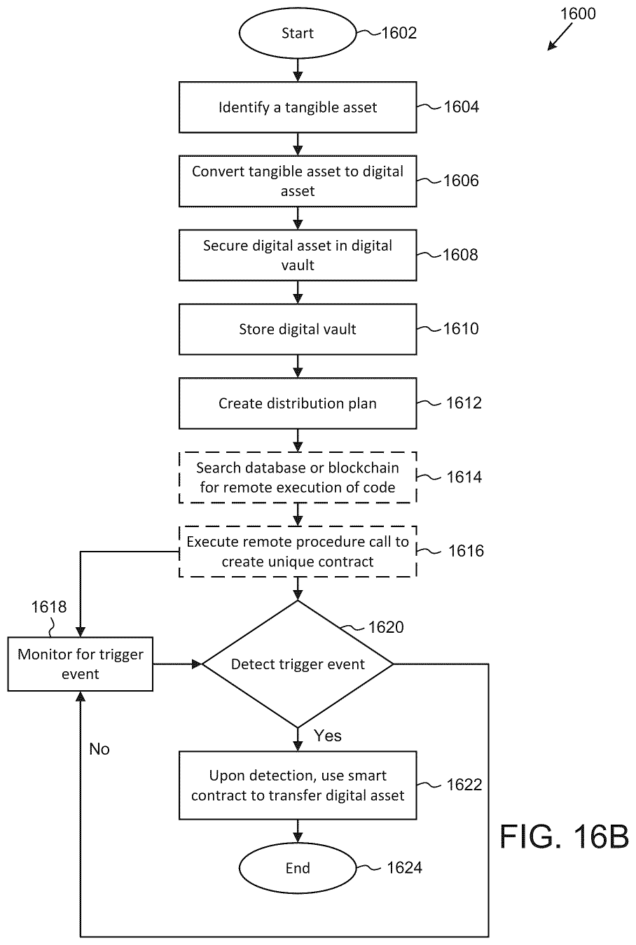

Referring to FIG. 16A, a method 1600 of digitally securing and transferring assets is illustrated in a flow diagram beginning at 1602. At 1604, a tangible asset is identified. Digital records are collected regarding the tangible asset. At 1606, the tangible asset is converted to a digital asset using the digital records. At 1608, the digital asset is secured in a digital vault, preferably with a unique key to cryptographically secure the digital asset. At 1610, the digital asset is stored in a database or blockchain. At 1612, a distribution plan is created by a user including a trigger event. At 1618, the method monitors for the trigger event. At 1620, it is determined if the trigger event is found. If the trigger event is found, flow branches “YES” to 1622. At 1622, the distribution plan is used to transfer the digital asset to at least one beneficiary. Flow ends at 1624. Referring back to 1620, if it is determined that the trigger event is not found, then flow branches “NO” back to 1618 to continue monitoring for a trigger event.

Referring to FIG. 16B, a method 1600 of digitally securing and transferring assets is illustrated in a flow diagram beginning at 1602. At 1604, a tangible asset is identified. Digital records are collected regarding the tangible asset. At 1606, the tangible asset is converted to a digital asset using the digital records. At 1608, the digital asset is secured in a digital vault, preferably with a unique key to cryptographically secure the digital asset. At 1610, the digital asset is stored in a database or blockchain. At 1612, a distribution plan is created by a user including a trigger event. At 1614, a remote execution of code is searched for either within the BQuest system or outside the system. In other cases, a smart contract is searched for. At 1616, a selected remote procedure call is executed. Alternatively, a selected smart contract is executed to create a unique contract. At 1618, the method monitors for the trigger event. At 1620, it is determined if the trigger event is found. If the trigger event is found, flow branches “YES” to 1622. At 1622, the unique contract is used to transfer the digital asset to at least one beneficiary. Flow ends at 1624. Referring back to 1620, if it is determined that the trigger event is not found, then flow branches “NO” back to 1618 to continue monitoring for a trigger event.

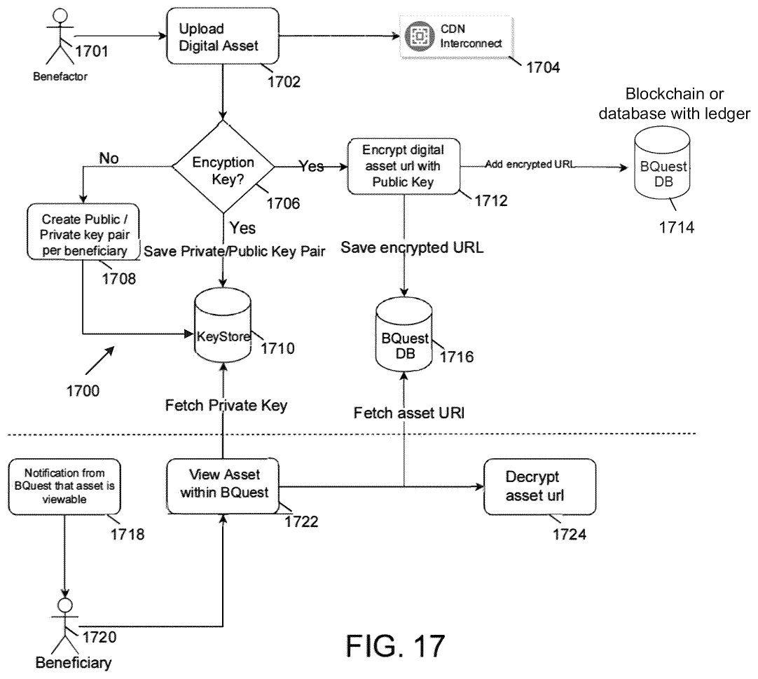

Referring to FIG. 17, a method 1700 of securing an asset is illustrated. At 1702, a user or benefactor uploads a digital asset, such as an asset 200 of FIG. 2. At 1704, a CDN Interconnect is used to create a URL for the digital asset. CDN Interconnect is a content delivery network interconnection, which is a set of interfaces and mechanisms required for interconnecting two independent content delivery networks that enables one to deliver content on behalf of the other. At 1706, it is determined if there is an encryption key. If at 1706, it is determined there is not an encryption key, flow branches “NO” to 1708 and a public/private key pair is created for each beneficiary. At 1710, the public/private key pair is stored in the keystore database. Referring back to 1706, if there is an encryption key, the flow branches “YES” to both 1710 and the key is stored in the keystore and to 1712. At 1712, the digital asset URL is encrypted with the key. At 1714, the encrypted URL is added to the database, or blockchain. As such, the digital asset is cryptographically locked in the database, or blockchain. At 1716, the encrypted URL is also saved in a database.

At 1718, a notification is sent to a beneficiary 1720 that the asset is viewable. At 1722, the key is fetched from the keystore 1710 and the asset is fetched from the database 1716. The key is used to decrypt the asset at 1724 for viewing by the beneficiary 1720.

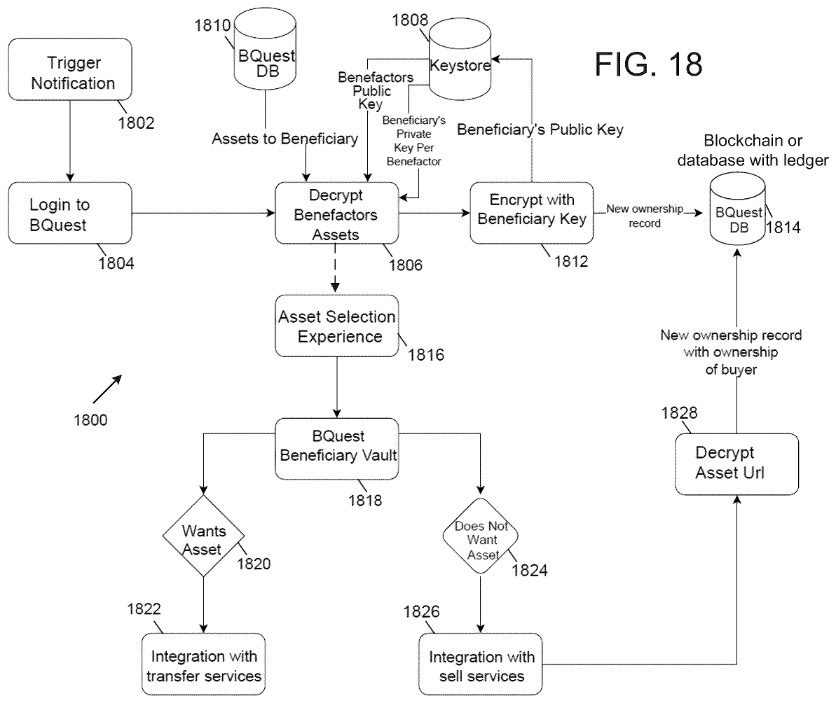

Referring to FIG. 18, a method 1800 of transferring a digital asset is illustrated. At 1802 a trigger notification is received by a beneficiary. At 1804, the beneficiary logs into the system. At 1806, the benefactors assets are decrypted using the keys from the keystore 1808 and retrieving the assets from the database 1810. At 1812, the assets are encrypted with a new key for the beneficiary and the new ownership, by the beneficiary, record is stored in the database, or blockchain 1814. Referring back to 1806, alternatively, an asset selection experience 1816 could be used. At 1818, the beneficiary could decide if he/she wants an asset or does not want the asset. For example, the beneficiary may want a car but not want a table and chair set. At 1820, the beneficiary selects the car, and at 1822, the system integrates with transfer services to transfer the car to the beneficiary. At 1824, the beneficiary selects he/she does not want the table and chair set. At 1826, the system integrates with sell services and market valuation data to sell the table and chair set. At 1828, the new buyer of the table and chair set would be reflected in the ownership chain.

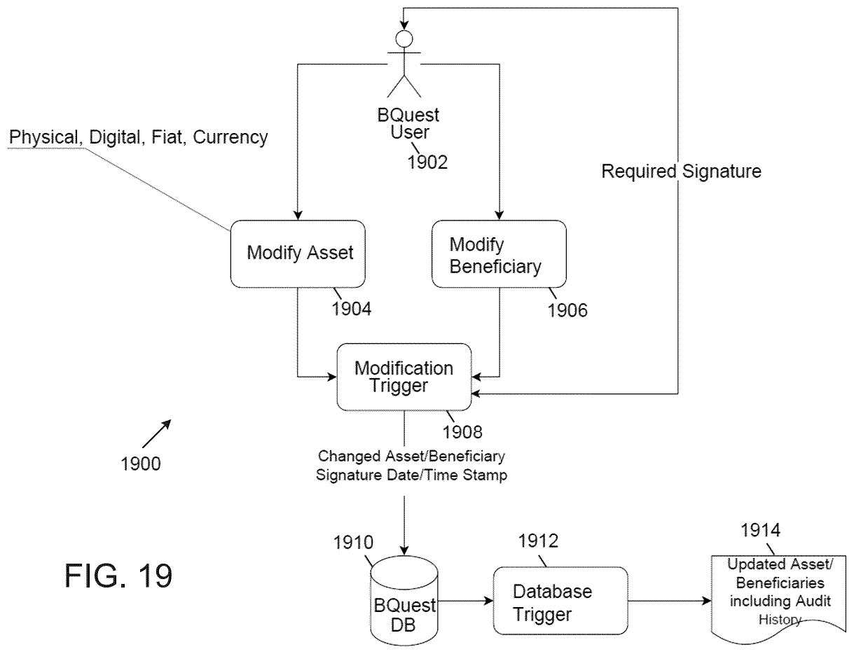

Referring to FIG. 19, a method 1900 of modifying a distribution plan is illustrated. In general, the distribution plan includes assets and beneficiaries. A user 1902 or benefactor can modify an asset at 1904. This can include adding or subtracting assets or changing the values of one or more assets. The user can also modify a beneficiary at 1906. This can include adding or subtracting beneficiaries or modifying beneficiaries, for example by changing percentages that each beneficiary receives. At 1908, a modification trigger is detected by either a modification to an asset at 1904 or a beneficiary at 1906. A signature is then required from the user 1902 in order to make any modifications to the assets. If a signature is received from the user 1902, the change is recorded to the database 1910 along with the signature and date/time stamp. At 1912, a database trigger causes the updated assets/beneficiaries to be uploaded including an audit history. If the user does not sign, no changes are recorded.

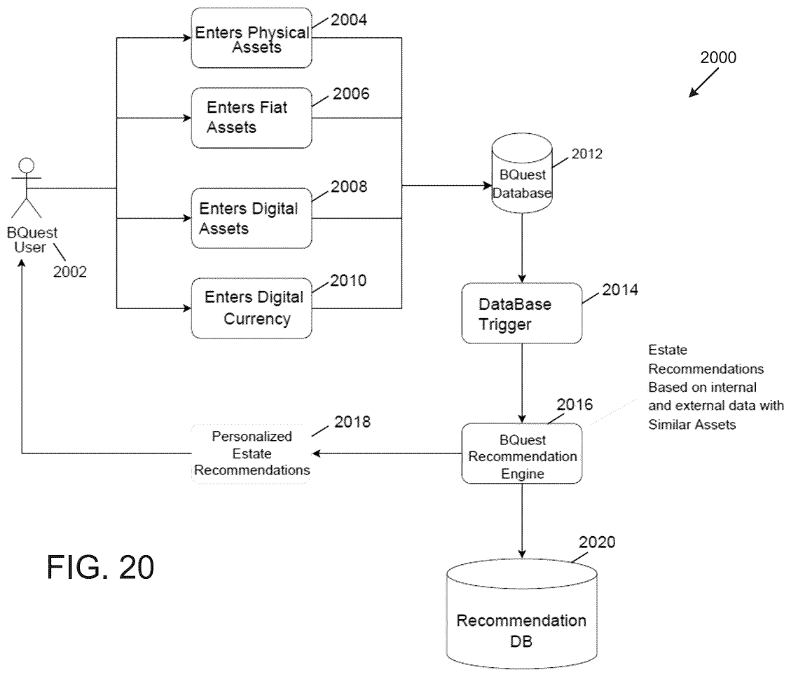

Referring to FIG. 20, a method 2000 of making estate recommendations is illustrated. A user 2002 enters physical assets 2004, fiat assets 2006, digital assets 2008 and digital currency 2010. The assets are saved in a database 2012. At 2014, a database trigger causes a recommendation engine 2016 to analyze the asset sizes and allocations of the estate of the user and compares them to internal and external objective data on what other users with similar asset make-ups have done for estate plans. The comparison can include comparing the allocations and values within a target range of the estate, for example plus or minus 10%. The target range could be input by the user. At 2018, a personalized estate recommendation is created for the user 2002 based on that objective data for the user 2002 to consider. The recommendation could be based on an average of the comparison to the objective data. The recommendation could be also based on leveraging Artificial Intelligence (AI) systems that have incorporated the data from the system. The analysis and/or recommendation can also be saved to a database 2020.

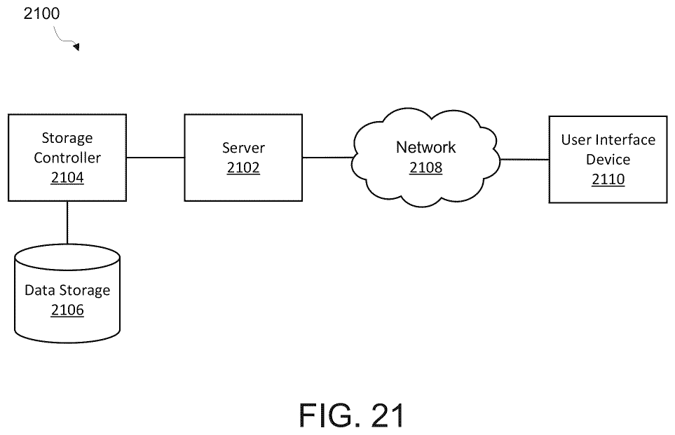

FIG. 21 illustrates a computer network 2100 for obtaining access to software, directories, files, meta-data, and assemblies of files in a computing system according to one embodiment of the disclosure. The system 2100 may include a server 2102, a data storage device 2106, a network 2108, and a user interface device 2110. The server 2102 may also be a hypervisor-based system executing one or more guest partitions hosting operating systems with modules having server configuration information. In a further embodiment, the system 2100 may include a storage controller 2104, or a storage server configured to manage data communications between the data storage device 2106 and the server 2102 or other components in communication with the network 2108. In an alternative embodiment, the storage controller 2104 may be coupled to the network 2108. In another embodiment, the network 2100 may utilize virtual hardware and virtual machines which put a server 2102, a data storage device 2106, and a user interface device 2110 on the internet (“the cloud”) and which may be expanded based on need.

In one embodiment, the user interface device 2110 is referred to broadly and is intended to encompass a suitable processor-based device such as a desktop computer, a laptop computer, a personal digital assistant (PDA) or tablet computer, a smartphone or other mobile communication device having access to the network 2108. In a further embodiment, the user interface device 2110 may access the Internet or other wide area or local area network to access a web application or web service hosted by the server 2102 and may provide a user interface for enabling a user to enter or receive information.

The network 2108 may facilitate communications of data between the server 2102 and the user interface device 2110. The network 2108 may include any type of communications network including, but not limited to, a direct PC-to-PC connection, a local area network (LAN), a wide area network (WAN), a modem-to-modem connection, the Internet, a combination of the above, or any other communications network now known or later developed within the networking arts which permits two or more computers to communicate.

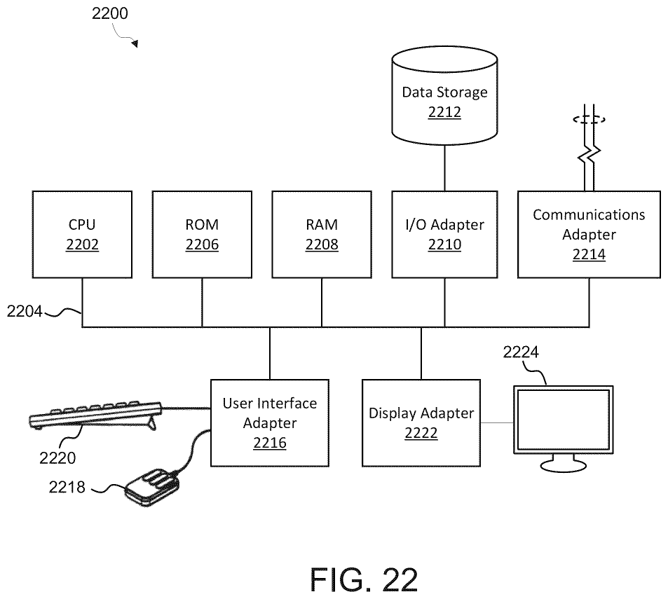

FIG. 22 illustrates a computer system 2200 adapted according to certain embodiments of the server 2102 and/or the user interface device 2110. The central processing unit (“CPU”) 2202 is coupled to the system bus 2204. The CPU 2202 may be a general purpose CPU or microprocessor, graphics processing unit (“GPU”), and/or microcontroller. The present embodiments are not restricted by the architecture of the CPU 2202 so long as the CPU 2202, whether directly or indirectly, supports the operations as described herein. The CPU 2202 may execute the various logical instructions according to the present embodiments.

The computer system 2200 may also include random access memory (RAM) 2208, which may be synchronous RAM (SRAM), dynamic RAM (DRAM), synchronous dynamic RAM (SDRAM), or the like. The computer system 2200 may utilize RAM 2208 to store the various data structures used by a software application. The computer system 2200 may also include read only memory (ROM) 2206 which may be PROM, EPROM, EEPROM, optical storage, or the like. The ROM may store configuration information for booting the computer system 2200. The RAM 2208 and the ROM 2206 hold user and system data, and both the RAM 2208 and the ROM 2206 may be randomly accessed.

The computer system 2200 may also include an I/O adapter 2210, a communications adapter 2214, a user interface adapter 2216, and a display adapter 2222. The I/O adapter 2210 and/or the user interface adapter 2216 may, in certain embodiments, enable a user to interact with the computer system 2200. In a further embodiment, the display adapter 2222 may display a graphical user interface (GUI) associated with a software or web-based application on a display device 2224, such as a monitor or touch screen.

The I/O adapter 2210 may couple one or more storage devices 2212, such as one or more of a hard drive, a solid state storage device, a flash drive, a compact disc (CD) drive, a floppy disk drive, and a tape drive, to the computer system 2200. According to one embodiment, the data storage 2212 may be a separate server coupled to the computer system 2200 through a network connection to the I/O adapter 2210. The communications adapter 2214 may be adapted to couple the computer system 2200 to the network 2108, which may be one or more of a LAN, WAN, and/or the Internet. The user interface adapter 2216 couples user input devices, such as a keyboard 2220, a pointing device 2218, and/or a touch screen (not shown) to the computer system 2200. The display adapter 2222 may be driven by the CPU 2202 to control the display on the display device 2224. Any of the devices 2202-2222 may be physical and/or logical.

The applications of the present disclosure are not limited to the architecture of computer system 2200. Rather the computer system 2200 is provided as an example of one type of computing device that may be adapted to perform the functions of the server 2102 and/or the user interface device 2210. For example, any suitable processor-based device may be utilized including, without limitation, IoT devices, tablet computers, smartphones, computer game consoles, and multi-processor servers. Moreover, the systems and methods of the present disclosure may be implemented on application specific integrated circuits (ASIC), very large scale integrated (VLSI) circuits, or other circuitry. In fact, persons of ordinary skill in the art may utilize any number of suitable structures capable of executing logical operations according to the described embodiments. For example, the computer system 2200 may be virtualized for access by multiple users and/or applications.

If implemented in firmware and/or software, the functions described above may be stored as one or more instructions or code on a computer-readable medium. Examples include non-volatile computer-readable media encoded with a data structure and computer-readable media encoded with a computer program. Computer-readable media includes physical computer storage media. A storage medium may be any available medium that can be accessed by a computer. By way of example, and not limitation, such computer-readable media can comprise RAM, ROM, EEPROM, CD-ROM or other optical disk storage, solid-state storage, flash memory, magnetic disk storage or other magnetic storage devices, or any other medium that can be used to store desired program code in the form of instructions or data structures and that can be accessed by a computer. Disk and disc includes compact discs (CD), laser discs, optical discs, digital versatile discs (DVD), floppy disks and blu-ray discs. Generally, disks reproduce data magnetically, and discs reproduce data optically. Generally, solid-state storage use electronic circuits to reproduce data, including flash memory. Combinations of the above should also be included within the scope of computer-readable media.

In addition to storage on computer-readable medium, instructions and/or data may be provided as signals on transmission media included in a communication apparatus. For example, a communication apparatus may include a transceiver having signals indicative of instructions and data. The instructions and data are configured to cause one or more processors to implement the functions outlined in the claims.

We claim:

1. A method of digitally securing and transferring assets, the method comprising:
securing an asset in a digital vault using a unique key;
storing the digital vault in a first database and storing the unique key in a second database separate from the first database;
creating a distribution plan for the asset;
detecting a trigger event; and
upon detecting the trigger event, transferring the asset;
wherein an asset can be secured in a database using a unique key and automatically distributed upon detection of a trigger event.

2. The method of claim 1, further comprising the automated creation of legal documents.

3. The method of claim 2, further comprising the creation of a unique contract per asset.

4. The method of claim 3, wherein the unique contract is used to detect the trigger event.

5. The method of claim 1, wherein the trigger event is a date in time.

6. The method of claim 1, wherein the digital asset is a photo, video, token, or cryptocurrency.

7. The method of claim 1, further comprising identifying a tangible asset and converting the tangible asset to a digital asset.

8. The method of claim 1, wherein transferring the asset includes selling the asset and obtaining market valuation using data collected from the asset.

9. The method of claim 1, wherein securing a digital asset includes encrypting a url of the digital asset and storing the digital vault in a database includes adding the encrypted url to the database.

10. A method of transferring a digital asset, the method comprising:
upon detecting a trigger event, retrieving a benefactor's public key from a keystore;
retrieving a beneficiary's private key from the key store;
using the public key and the private key to decrypt the digital asset;
encrypt the digital asset with a new beneficiary public key;
store the new beneficiary public key in the keystore;
store the digital asset in a database to reflect the new ownership record.

11. The method of claim 10, further comprising loading the digital asset in a vault and presenting the digital asset to a user for a decision to transfer the digital asset.

12. The method of claim 11, further comprising if the user selects transfer of the digital asset, integrating with a transfer service to initiate transfer of the digital asset.

13. The method of claim 12, wherein the digital asset is a physical asset.

14. The method of claim 13, wherein transfer of the physical asset includes physically moving the physical asset to a different location.

15. The method of claim 12, further comprising if the user selects not to transfer the digital asset, integrating with a sell services to sell the asset.

16. The method of claim 15, further comprising decrypting the digital asset and saving to the blockchain to reflect the new ownership record.

17. A method of creating an estate recommendation, the method including:
receiving a database trigger for a first estate in a database that includes an allocation of asset types and values by asset types;
comparing the allocation and values to other estates in the database having a similar allocation and values to create a first comparison;
comparing the allocation and market values to other estates in an external database having a similar allocation and values to create a second comparison; and
using the first and second comparison to create a recommendation for the first estate automatically without any other input.

18. The method of claim 17, wherein comparing the allocation and values to other estates in the database includes comparing the allocation and values within a first target range of the allocation and a second target range of the values.

19. The method of claim 18, wherein the first and second target range is input by the user.

20. The method of claim 17, wherein to create a first comparison includes to create a first comparison using an average of the other estates in the database.
